(19) United States
(12) Patent Application Publication
(10) Pub. No.: US 2025/0068298 A1
(43) Pub. Date: Feb. 27, 2025

(54) IMAGE GENERATION METHOD AND APPARATUS, COMPUTER DEVICE, AND STORAGE MEDIUM

(71) Applicant: Beijing Volcano Engine Technology Co., Ltd., Beijing (CN)

(72) Inventors: Chenying WANG, Beijing (CN); Chaoying CAI, Beijing (CN); Hanyao SHAO, Beijing (CN)

(21) Appl. No.: 18/811,594

(22) Filed: Aug. 21, 2024

(30) Foreign Application Priority Data
Aug. 24, 2023 (CN) 202311077757.6

(51) Int. Cl. G06F 3/0482; G06F 3/04845; G06T 11/00

(52) U.S. Cl. CPC G06F 3/0482; G06F 3/04845; G06T 11/00; G06T 2200/24

(57) ABSTRACT

The present disclosure provides an image generation method and apparatus, a computer device, and a storage medium. The image generation method includes: displaying a target interface for performing intelligent image generation, the target interface displaying a plurality of style reference materials, and each style reference material including style indication information and a corresponding sample image; determining a target style reference material selected from the plurality of style reference materials by a user, and obtaining input information from the user in an image generation mode that is selected; and according to the input information in the image generation mode and the target style reference material, generating and displaying at least one target image.

### CROSS-REFERENCE TO RELATED APPLICATION

This application claims the priority to and benefits of the Chinese patent application No. 202311077757.6, which was filed on Aug. 24, 2023. All the aforementioned patent application is hereby incorporated by reference in their entireties.

### TECHNICAL FIELD

The present disclosure relates to an image generation method and apparatus, a computer device, and a storage medium.

### BACKGROUND

The creation of game screens, production of background images and illustrations in application interfaces etc., will involve the creation of images.

For the creation of images, if a user does not have a professional basis for painting, he/she can use some image generation tools to create images, but these image generation tools when used for generating relevant images for the user generally require the user to accurately express the images he/she wants to generate, and if the user does not make accurate representation or does not know how to describe the expected image information, the generated images will hardly meet his/her expectation.

### SUMMARY

Embodiments of the present disclosure provide at least an image generation method and apparatus, a computer device, and a storage medium.

An embodiment of the present disclosure provides an image generation method, and the method comprises: displaying a target interface for performing intelligent image generation, the target interface displaying a plurality of style reference materials, and each of the plurality of style reference materials comprising style indication information and a corresponding sample image; determining a target style reference material selected from the plurality of style reference materials by a user, and obtaining input information from the user in an image generation mode that is selected; and according to the input information in the image generation mode and the target style reference material, generating and displaying at least one target image.

In an optional implementation, the image generation mode selected by the user is a text-to-image mode, and the text-to-image mode refers to generating an image based on text information; the obtaining input information from the user in an image generation mode that is selected comprises: determining and displaying first text description reference information based on the target style reference material selected by the user; and obtaining the input information obtained by editing the first text description reference information by the user.

In an optional implementation, the image generation mode selected by the user is an image-to-image mode, and the image-to-image mode refers to generating an image based on image information; the obtaining input information from the user in an image generation mode that is selected comprises: obtaining an original image uploaded by the user, or, obtaining an original image uploaded by the user and description information for the original image, the original image being from a local client of the user or from a target platform.

In an optional implementation, obtaining the description information for the original image from the user comprises: determining and displaying second text description reference information according to the original image uploaded by the user and the target style reference material selected by the user; and obtaining description information obtained by editing the second text description reference information by the user as the description information for the original image.

In an optional implementation, before the generating and displaying at least one target image, the method further comprises: obtaining parameter information input by the user in response to at least one image generation parameter that is set. The according to the input information in the image generation mode and the target style reference material, generating and displaying at least one target image comprises: according to the parameter information input by the user for the at least one image generation parameter, the input information, and the target style reference material, generating and displaying the at least one target image.

In an optional implementation, in response to the image generation mode selected by the user being an image-to-image mode, the at least one image generation parameter comprises at least one selected from a group comprising an image structure retention intensity and a texture retention intensity; the image-to-image mode refers to generating an image based on image information, the image structure retention intensity is used for indicating a retention degree of edge lines of the original image uploaded by the user, and the texture retention intensity is used for indicating a retention degree of image texture of the original image uploaded by the user.

In an optional implementation, the method further comprises: displaying at least one image processing control; and in response to an image processing request for any one target image of the at least one target image, processing the target image to obtain a processed image in accordance with an image processing mode corresponding to a selected image processing control.

In an optional implementation, the at least one image processing control comprises at least one of following controls: a first control corresponding to a super-resolution processing mode, a second control corresponding to a variation processing mode, a third control corresponding to an image-matting processing mode, and a fourth control corresponding to a creation-similar image processing mode. The super-resolution processing mode refers to performing zoom-in processing on an image, the zoom-in processing refers to performing simultaneous zoom-in processing on an image in terms of resolution and size; the image-matting processing mode refers to performing foreground pixel extraction processing on an image; the variation processing mode refers to performing image detail adjustment processing on a premise of maintaining a consistent image style; the creation-similar image processing mode refers to recreating an image by adopting input information that is same as input information of a corresponding image, and after the fourth control is triggered, displaying the input information of the corresponding image again in the target interface.

In an optional implementation, the displaying at least one image processing control comprises: in response to a triggering operation for a control list button displayed at a position of the target image, displaying the at least one image processing control at the position of the target image; or, displaying a plurality of image generation modes and the at least one image processing control in an image generation mode option bar of the target interface.

An embodiment of the present disclosure provides an image generation apparatus, which comprises: a display module, configured to display a target interface for performing intelligent image generation, the target interface displaying a plurality of style reference materials, and each of the plurality of style reference materials comprising style indication information and a corresponding sample image; an obtaining module, configured to determine a target style reference material selected from the plurality of style reference materials by a user, and obtain input information from the user in an image generation mode that is selected; and a generation module, configured to according to the input information in the image generation mode and the target style reference material, generate and display at least one target image.

An embodiment of the present disclosure provides a computer device, comprising a processor, a memory, and a bus, the memory stores machine-readable instructions executable by the processor, when the computer device runs, the processor is in communication with the memory via the bus, and when the machine-readable instructions are executed by the processor, steps of the image generation method described in any embodiment of the present disclosure are performed.

An embodiment of the present disclosure provides a non-transitory computer-readable storage medium, the non-transitory computer-readable storage medium stores a computer program, and when the computer program is executed by a processor, steps of the image generation method described in any embodiment of the present disclosure are performed.

In order to make the above objectives, features, and advantages of the present disclosure more obvious and understandable, the following embodiments, in conjunction with the accompanying drawings, are described in detail as follows.

### BRIEF DESCRIPTION OF DRAWINGS

In order to illustrate the technical solutions of the embodiments of the present disclosure more clearly, the accompanying drawings needed to be used in the embodiments will be briefly introduced below, the accompanying drawings herein are incorporated into and constitute a part of this specification, these accompanying drawings illustrate embodiments consistent with the present disclosure and are used in conjunction with the specification to illustrate the technical solutions of the present disclosure. It should be understood that the following drawings show only certain embodiments of the present disclosure, and therefore should not be regarded as limiting the scope of the present disclosure. Apparently, other accompanying drawings can also be derived from these drawings by those ordinarily skilled in the art without creative efforts.

FIG. 1 shows a flowchart of an image generation method according to an embodiment of the present disclosure;

FIG. 2 shows a schematic diagram of a target interface in a text-to-image mode in the image generation method according to an embodiment of the present disclosure;

FIG. 3 shows a schematic diagram of a target interface in an image-to-image mode in the image generation method according to an embodiment of the present disclosure;

FIG. 4 shows a schematic diagram of a parameter setting interface added and displayed in the text-to-image mode in the image generation method according to an embodiment of the present disclosure;

FIG. 5 shows a schematic diagram of a parameter setting interface added and displayed in the image-to-image mode in the image generation method according to an embodiment of the present disclosure;

FIG. 6 shows a schematic diagram after target images are generated in the image generation method according to an embodiment of the present disclosure;

FIG. 7 shows a schematic diagram of an image generation apparatus according to an embodiment of the present disclosure; and

FIG. 8 shows a schematic diagram of a computer device according to an embodiment of the present disclosure.

### DETAILED DESCRIPTION

In order to make the purposes, technical solutions, and advantages of the embodiments of the present disclosure clearer, the technical solutions in the embodiments of the present disclosure will be clearly and completely described below in conjunction with the accompanying drawings in the embodiments of the present disclosure. Obviously, the described embodiments are only a portion of the embodiments of the present disclosure and not all of the embodiments of the present disclosure. Generally, the components of the embodiments of the present disclosure described and illustrated in the accompanying drawings herein may be arranged and designed in a variety of different configurations. Accordingly, the following detailed description of the embodiments of the present disclosure provided in the accompanying drawings is not intended to limit the scope of the present disclosure for which protection is claimed, but rather represents only selected embodiments of the present disclosure. Based on the embodiments of the present disclosure, all other embodiments obtained by a person skilled in the art without creative efforts fall within the scope of protection of the present disclosure.

It has been found through research that for the creation of images, some image generation tools may be used to create images, but these image generation tools when used for generating relevant images for a user generally require the user to accurately express the images he/she wants to generate, and if the user does not make accurate representation or does not know how to describe the expected image information, the generated images will hardly meet his/her expectation.

Based on the above research, an embodiment of the present disclosure provides an image generation method, which includes first providing a plurality of style reference materials before generating a target image, allowing a user to select a style reference material that meets the user's expectation based on the style indication information and the corresponding image sample included in each style reference material, and based on this, generating a target image matched with the style reference material according to obtained input information in an image generation mode selected by the user. In this way, by displaying the style reference material including the image sample and the style indication information, it is convenient for the user to refer to the image sample and the style description to confirm the target style reference material of interest. Based on the target style reference material and the input information in the selected image generation mode from the user, the target images that meet the user's expectation can be generated more accurately.

In any embodiment of the present disclosure, a function of generating the target image based on the input information and the selected style reference material is provided for a user; specifically, after the target interface for intelligent image generation is displayed, at least one target image is generated by obtaining the target style reference material selected by the user in the target interface and the input information in the selected image generation mode from the user; each target style reference material comprises style indication information and a corresponding image sample; in this way, by displaying the style reference material comprising the image sample and the style indication information, it may be convenient for the user to confirm the target style reference material of interest by referring to the image sample and the style description; and based on the target style reference material and the input information under the selected image generation mode from the user, the target image meeting the user's expectation may be generated more accurately.

In addition, for the input information that needs to be input by the user, an embodiment of the present disclosure further provides a solution for providing the user with relevant text description reference information. Based on the text description reference information, the user may directly edit the input information, compared with the method of allowing the user to directly write the input information, the method provided in the embodiments of the present disclosure may, on one hand, improve the writing efficiency of input information, and may, on the other hand, also reduce the editing threshold for the user to obtain the target image.

Further, embodiments of the present disclosure further provide some parameter adjustment methods for finely controlling the target image, and a processing method for quickly obtaining an updated image by performing one-click processing on the generated target image. Specific descriptions are provided below.

The problems proposed above and the solutions all are the result obtained by the inventor after practice and careful research, the process of discovering the above-mentioned problems and the solution proposed to address the above-mentioned problems should all be the inventor's contribution to the present disclosure.

The technical solutions in the present disclosure will be described clearly and completely below with reference to the accompanying drawings in the present disclosure. Apparently, the described embodiments are merely some but not all of the embodiments of the present disclosure. Generally, components of the present disclosure described and illustrated in the accompanying drawings herein may be arranged and designed in a variety of different configurations. Accordingly, the following detailed description of the embodiments of the present disclosure provided in the accompanying drawings is not intended to limit the scope of the present disclosure for which protection is claimed, but rather shows only the selected embodiments of the present disclosure. All other embodiments obtained by a person skilled in the art based on the embodiments of the present disclosure without making any creative effort shall fall within the protection scope of the present disclosure.

It should be noted that similar reference numerals and letters denote similar items in the following accompanying drawings, and therefore, once an item is defined in one drawing, it does not need to be further defined or explained in the subsequent drawings.

In order to facilitate the understanding of the embodiments, the image generation method provided in the embodiments of the present disclosure is first described in detail. The execution subject of the image generation method provided in the embodiment of the present disclosure is generally a computer device having certain computing capabilities. The computer device includes, for example, a terminal device or a server or other processing devices, and the terminal device may be a UE (User Equipment), a mobile device, a user terminal, a terminal, a cellular phone, a cordless phone, a PDA (Personal Digital Assistant), a handheld device, a computing device, an in-vehicle device, a wearable device, and the like. In some possible implementations, the image generation method may be implemented by way of a processor calling computer-readable instructions stored in a memory.

The image generation method provided in the embodiment of the present disclosure is described below by taking an example in which the execution subject is a terminal device.

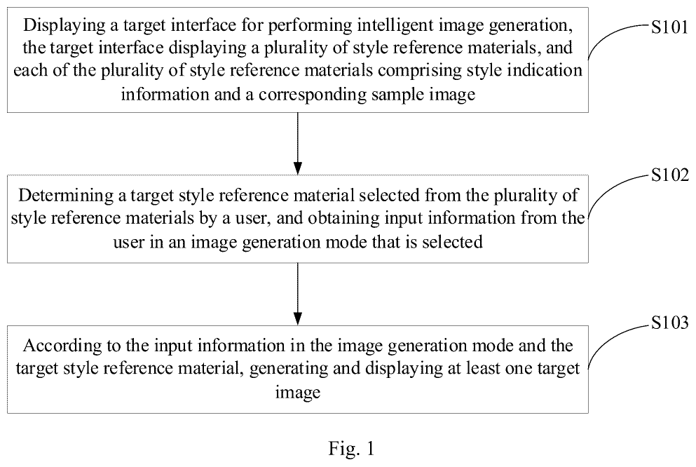

Referring to FIG. 1, a flowchart of an image generation method according to an embodiment of the present disclosure is shown. The method includes steps S101-S103 as below.

S101: displaying a target interface for performing intelligent image generation, the target interface displaying a plurality of style reference materials, and each of the plurality of style reference materials comprising style indication information and a corresponding sample image.

Here, after entering the target interface of intelligent image generation, a user may select a style reference material that meets the requirement among the plurality of style reference materials in the target interface, and each style reference material comprises the style indication information and the corresponding image sample.

In addition, in some embodiments of the present disclosure, after the target image is generated, functions of performing image-matting, super-resolution, variation, and similar creation to the target image are also provided, so that when the user has corresponding needs for the target image, the processing of the target image can be completed by triggering the corresponding control. In this way, time for subsequent additional processing on the target image can be saved for the user, a processed image that meets the user's needs can be generated by one-click processing, and thus the efficiency of generating an image that meets the user's expectation is improved.

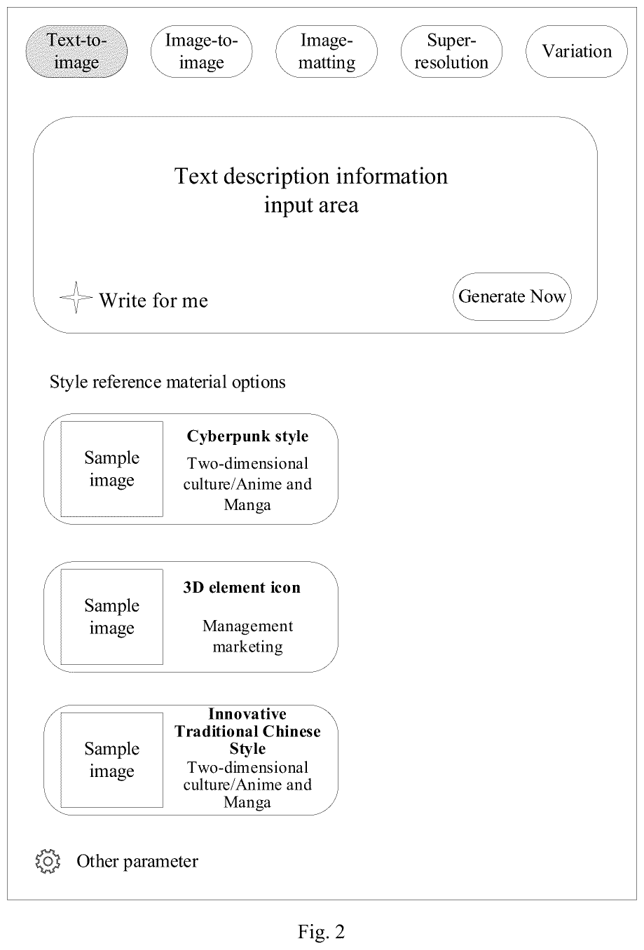

In the embodiment of the present disclosure, a schematic diagram of a target interface is shown in FIG. 2. A tab bar is provided in the target interface. The user may select a corresponding image generation mode from the tab bar, such as an option of “Text-to-image” and an option of “Image-to-image” in FIG. 2. In addition, various image processing modes, such as “Image-matting”, “Super-resolution”, and “Variation”, are also provided in the tab bar so as to facilitate the user to perform the corresponding image processing on a generated target image or other locally uploaded images. For the specific processing modes, reference may be made to the description of the relevant content of the subsequent step S103.

In the embodiment of the present disclosure, a plurality of style reference material options are also provided in the target interface, and each style reference material includes a corresponding style name, style indication information, and an image sample. For example, in style reference material options shown in FIG. 2, the style indication information corresponding to one of the style reference materials includes a style name of “Cyberpunk style” and a style description of “Two-dimensional culture/Anime and Manga”. In addition, each style reference material also gives a corresponding image sample, such that the user can more intuitively view and select an image style that meets the user's expectation in the target interface, and accordingly can select the style reference material more accurately and purposely. After the style reference material and the input information selected by the user are provided to an artificial intelligence model, the artificial intelligence model may generate a target image that matches the style reference material and the input information selected by the user, so that the generated target image is not so much different from the user's expectation due to insufficient description of the input information.

In addition, other parameter setting buttons are also provided in the target interface, and after the user triggers the button, a display parameter setting page may be added outside the current target page. The specific implementation process is described in detail in S103 and will not be repeated here.

S102: determining a target style reference material selected from the plurality of style reference materials by a user, and obtaining input information from the user in an image generation mode that is selected.

Here, in addition to selecting the target reference material among the plurality of style reference materials, the user may also select a desired image generation mode in the tab bar in the target interface, and may input information in the corresponding image generation mode in a corresponding input area. Here, the sequence of selecting the image generation mode in the tab bar, selecting the target reference material, and inputting the input information is not limited, and the user may choose which step to perform first according to his/her needs.

In a specific implementation, in response to the image generation mode selected by the user being a text-to-image mode, i.e., generating the target image based on the text information, in this case, the obtaining input information from the user in an image generation mode that is selected comprises: obtaining input information from the user in the text-to-image mode. The obtaining input information from the user in the text-to-image mode comprises: determining and displaying first text description reference information based on the target style reference material selected by the user; and obtaining the input information obtained by editing the first text description reference information by the user. In this image generation mode, in addition to the way in which the user edits the input information on his/her own, an embodiment of the present disclosure further provides a way of providing the user with initial input information: after the user selects the target style reference material, the artificial intelligence model may automatically generate the corresponding first text description reference information in a background and display the corresponding first text description reference information to the user in a text description information input area as shown in FIG. 2, and on this basis, the user may edit the first text description reference information; after finishing modifying and editing the first text description reference information, the user can click on a button of “Generate now” in the current interface to start to generate the corresponding target image.

In an embodiment of the present disclosure, the first text description reference information conforming to a style characterized by the target style reference material may be determined according to the target style reference material selected by the user and then displayed, and the user may edit the input information according to the first text description reference information, i.e., the user may make customized modifications to the input information on the basis of the first text description reference information, so that the target image generated finally better meets the user's needs.

The first text description reference information described above may be determined and displayed based on a preset corresponding relationship between each style reference material and the text description reference information after the user selects the target style reference material, or may also be automatically generated temporarily based on the target style reference material through the artificial intelligence model.

In a possible embodiment, after selecting the target style reference material, the user may instruct the artificial intelligence model to generate the first text description reference information by triggering a button of “Write for me” in the target interface. Then, the user may make customized modifications to the first text description reference information. After completing the modifications, the user may click on the button of “Generate now” in the current interface to instruct the artificial intelligence model to start to generate the corresponding target image.

Alternatively, in another possible embodiment, after the user selects the target style reference material, the initial first text description reference information can first be determined and displayed based on the preset corresponding relationship between each style reference material and the text description reference information, and then the user triggers the button of “Write for me” to instruct the artificial intelligence model to generate more detailed image description information associated with the current first text description reference information, and the user may also make customized modifications to the image description information. After completing the modifications, the user may click on the button of “Generate now” in the current interface to instruct the artificial intelligence model to start to generate the corresponding target image.

In a specific implementation, if the image generation mode selected by the user is an image-to-image mode, i.e., the target image is generated based on the image information, in this case, the obtaining input information from the user in an image generation mode that is selected comprises: obtaining input information from the user in the image-to-image mode. The step of obtaining the input information from the user in the image-to-image mode may include: obtaining an original image uploaded by the user, or, obtaining an original image uploaded by the user and description information for the original image; the original image is from a local client of the user or from a target platform. Here, the target platform may be considered as an application platform to which an image generation function (as a plug-in) provided in the embodiments of the present disclosure is accessed.

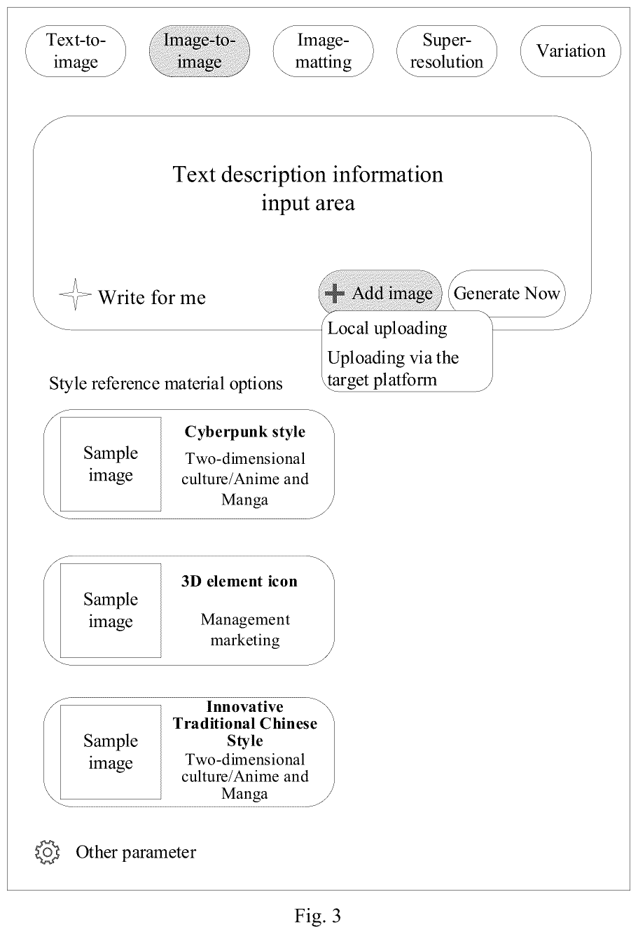

After the user selects the image-to-image mode as the image generation mode, the current interface is updated to a corresponding target interface in the image-to-image mode as shown in FIG. 3. Compared with the target interface in the text-to-image mode, the interface shown in FIG. 3 is additionally provided with a button of “Add image”. The user may trigger the button of “Add image” to select an image uploading mode as needed. The embodiment of the present disclosure includes image uploading modes: local uploading and uploading via the target platform. The actual application should be based on the actual situation, and no specific limitation is made herein.

In the image generation mode of image-to-image, the user may directly choose to generate the target image based on an image, or may additionally input text information in addition to uploading an image, so that the artificial intelligence model combines the uploaded image and the inputted text information to generate the target image.

In an implementation, after the user selects the target reference style material and completes the uploading of an original image, the artificial intelligence model may generate second text description reference information according to the target reference style material and the original image, and then display the second text description reference information to the user; on this basis, the user may make customized modifications and edits thereto. After completing the modifications and edits, the user may click on the button of “Generate now” in the current interface to instruct the artificial intelligence model to start to generate the corresponding target image.

In another possible embodiment, the artificial intelligence model may first determine the second text description reference information described above according to the target reference style material selected by the user and the uploaded original image, and display the second text description reference information to the user in a text description information input area in the target interface; and then, the user may instruct the artificial intelligence model to generate more detailed image description information associated with the current second text description reference information by triggering the button of “Write for me” in the current target interface; the user may also make customized modifications to the image description information; and after completing the modifications, the user may click on the button of “Generate Now” in the current interface to instruct the artificial intelligence model to start to generate the corresponding target image.

It should be noted here that, in the image-to-image mode, the generation of the target image is mainly based on the original image uploaded by the user, the corresponding text description information may be relatively concise, and the text description information here plays a role of auxiliary description in the process of generating the target image.

S103: according to the input information in the image generation mode and the target style reference material, generating and displaying at least one target image.

Here, after the user completes editing the input information for generating the target image and/or uploading the image, the user may click on the button of “Generate now” in the target interface to instruct the artificial intelligence model to generate the corresponding target image, and then display the generated target image to the user.

In the embodiment of the present disclosure, before the artificial intelligence model generates and displays the corresponding target image, the user may also adjust corresponding parameters in a parameter setting interface by triggering a button of “Other parameters” in the current interface, the parameter setting interface may be added for display in a preset area, such as a right side area, in the target interface.

Here, for the at least one image generation parameter that is set, the parameter information input by the user may be obtained; in the process that the artificial intelligence module generates the target image, in addition to the target style reference material and the input information described above, the parameter information can be also combined to assist in the generation of the target image.

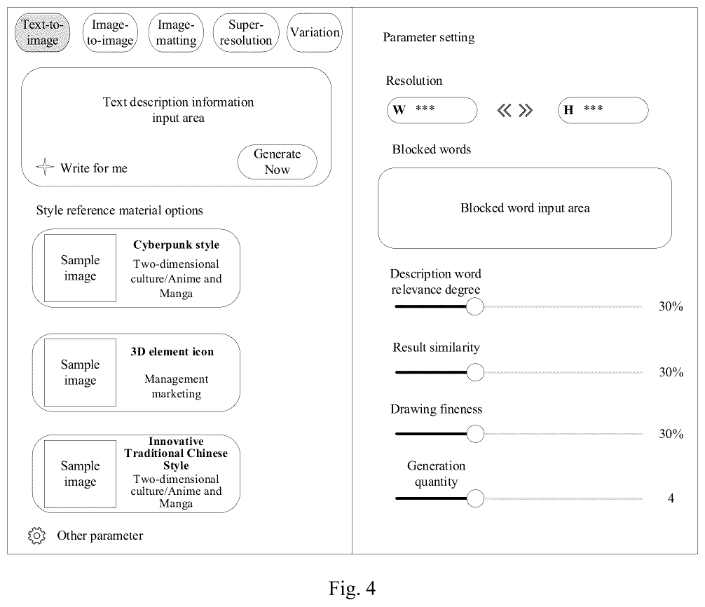

As shown in FIG. 4, a schematic diagram of a parameter setting interface, which is added and displayed, in the text-to-image mode is shown. In the parameter setting interface corresponding to the text-to-image mode, the embodiment of the present disclosure provides parameter setting options in multiple dimensions, such as resolution, blocked words, description word relevance degree, result similarity, drawing fineness, and generation quantity, and the user may slide a sliding scale or a slider located below the corresponding dimension to complete the adjustment of the parameter. It should be noted additionally that a corresponding input area may be provided below the option corresponding to the blocked words; and in the corresponding input area, the artificial intelligence model will give some general blocked word templates in advance, and the user may make customized modifications to the blocked word templates; in addition, the resolution may also be set by the user based on the user's needs. After finishing the adjustment of the parameters, the user may click on the button of “Generate now” in the target interface to instruct the artificial intelligence model to generate the corresponding target image based on the parameter setting information, the input information, and the selected target style reference material.

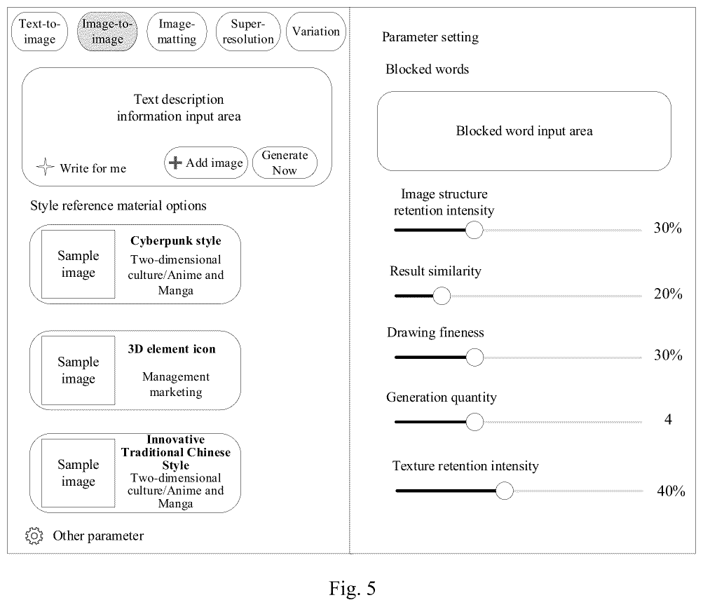

In another possible embodiment, as shown in FIG. 5, a schematic diagram of a parameter setting interface added and displayed in the image-to-image mode is shown. In the parameter setting interface corresponding to the image-to-image mode, compared with the parameter setting interface in the text-to-image mode described above, at least one of the image structure retention intensity and the texture retention intensity is additionally added, and the user can may also complete the adjustment of the corresponding parameter by sliding the sliding scale or slider located below the corresponding dimension. The image structure retention intensity is used to identify the edge lines of the uploaded original image, and accordingly, when generating the target image, the target image of a corresponding style may be generated according to the identified edge lines. The higher the value of the image structure retention intensity, the more edge lines are recognized, and the generated target image is more closely to and consistent with the contour of the original image. The texture retention intensity is used for indicating that the target image retains information such as the texture and/or hue of the original image. The higher the value of the texture retention intensity, the more similar the generated target image is to the original image.

In addition, the embodiments of the present disclosure can also provide different image generation modes. The target image may be generated based on text information (text-to-image mode), or the target image may be generated based on image information uploaded by the user (image-to-image mode). After the input information from the user in the selected image generation mode is obtained, the user is also supported to be able to adjust other parameters of the target image, such as resolution and description word relevance degree. Particularly, after the user selects the image-to-image mode as the image generation mode, it is possible to adjust the image structure retention intensity and the texture retention intensity, so as to adjust the retention degree of the edge lines and image texture of an original image, uploaded by the user, in the generated target image. In this way, while providing the user with more diverse image generation scenarios, more detailed parameter setting functions are also provided, and accordingly, a target image that meets the user's needs can be generated conveniently and efficiently.

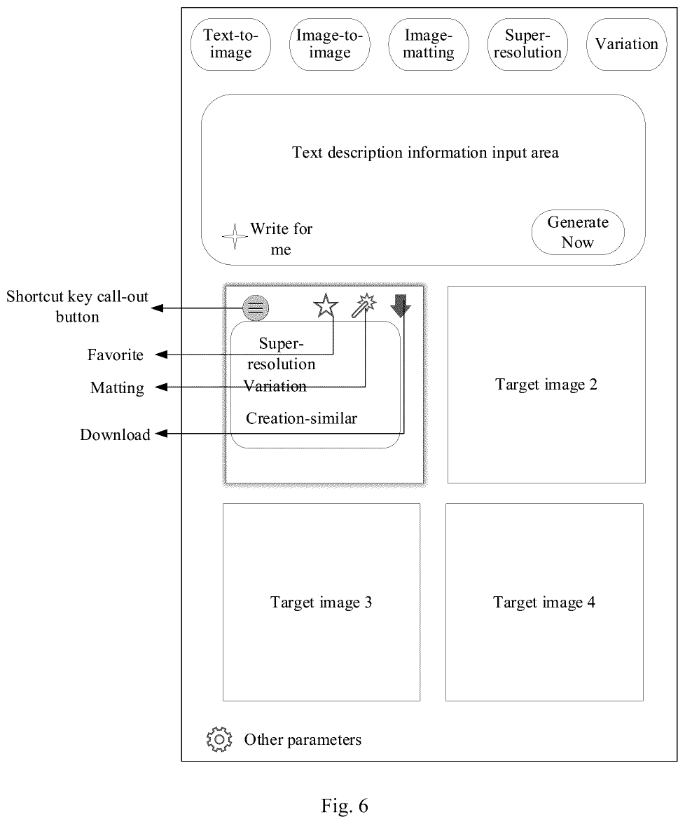

FIG. 6 shows a schematic diagram after a target image is generated. The generated target image is updated and then displayed in a style reference material area in the target interface. In the embodiment of the present disclosure, in addition to the image generation mode display bar described in S101, relevant image processing controls are also displayed above the generated target image.

In a specific implementation, if the user triggers any one of the target images, image processing controls are displayed above the corresponding target image, and if the user triggers one of the image processing controls, the corresponding image processing is performed on the selected target image. The image processing controls include at least one of the following: a first control corresponding to a super-resolution processing mode, a second control corresponding to a variation processing mode, a third control corresponding to an image-matting processing mode, and a fourth control corresponding to a creation-similar image processing mode. In addition, a fifth control for downloading a target image may further be included.

In the embodiment of the present disclosure, the “creation-similar” is used for reproducing descriptive information of the currently selected target image. When there is a need for the user to view the descriptive information used for generating the currently selected target image, the user may trigger this control to reproduce the corresponding descriptive information. Moreover, the control may also be used for regenerating a corresponding target image based on the existing descriptive information after being triggered. In the embodiment of the present disclosure, “Super-resolution” is used for synchronously zooming in on the resolution and size of the selected target image; “Variation” is used for adjusting the details of the selected target image on the premise of maintaining the consistency of the image style; “Image-matting” is used for performing foreground pixel extraction on the selected target image. It should be noted here that the target image after being subjected to the above processing may be directly uploaded to the target platform or saved locally.

In a specific implementation, because the image processing modes of “Image-matting”, “Super-resolution”, and “Variation” are actually equivalent to generating a new image, in the embodiment of the present disclosure, these image processing modes may be provided in the tab bar, together with the image generation modes of text-to-image and image-to-image. The “Super-resolution”, “Variation”, and “Creation-similar” are all used for re-creation of the generated target image. In order to facilitate one-click operation for the target image, in one implementation of the embodiment of the present disclosure, in response to the cursor being hovered over any image, a shortcut key call-out button shown in the upper-left corner of the image as shown in FIG. 6 may be displayed. In addition, the buttons of matting, download, and favorite shown in the upper-right corner of the image may also be displayed. The image processing controls of “Super-resolution”, “Variation” and “Creation-similar” may be displayed by triggering the shortcut key call-out button in the upper-left corner.

A person skilled in the art can understand that, in the specific implementation of the above-mentioned method, the order in which the steps are written does not imply a strict order of execution and does not constitute any limitation on the implementation process, and the specific execution order of the steps should be determined by their functions and possible internal logic.

Based on the same inventive concept, an embodiment of the present disclosure further provides an image generation apparatus corresponding to the image generation method. Because the principle of solving the problems by the apparatus in the embodiment of the present disclosure is similar to that of the above-mentioned image generation method in the embodiment of the present disclosure, the implementation of the apparatus may refer to the implementation of the method, and repeated descriptions are omitted.

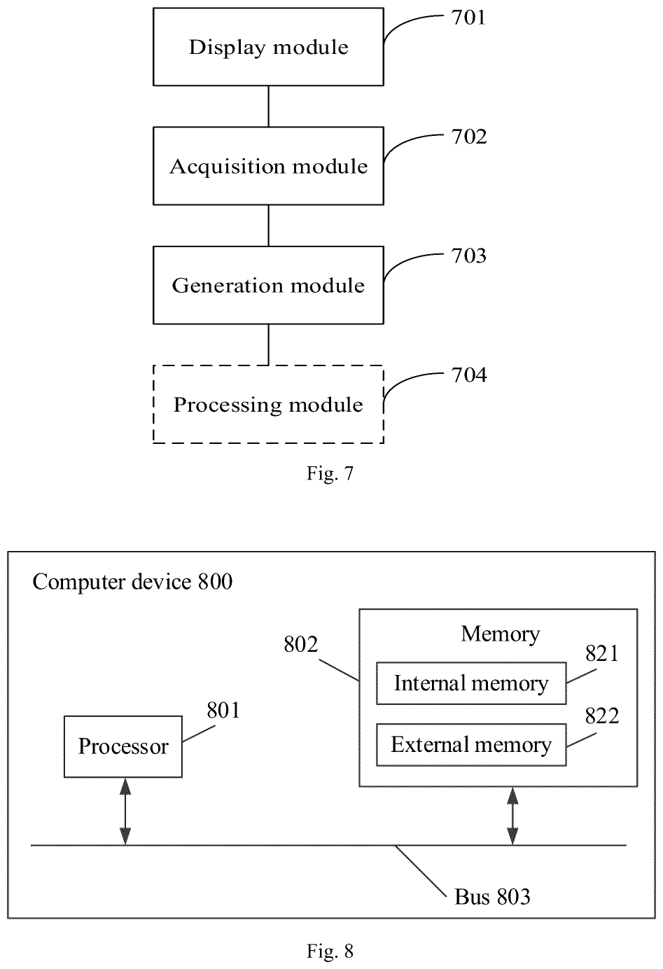

FIG. 7 is an architecture schematic diagram of an image generation apparatus according to an embodiment of the present disclosure. The apparatus includes a display module 701, an acquisition module 702, and a generation module 703.

The display module 701 is configured to display a target interface for performing intelligent image generation, the target interface displaying a plurality of style reference materials, and each of the plurality of style reference materials comprising style indication information and a corresponding sample image.

The acquisition module 702 is configured to determine a target style reference material selected from the plurality of style reference materials by a user, and obtain input information from the user in an image generation mode that is selected.

The generation module 703 is configured to, according to the input information in the image generation mode and the target style reference material, generate and display at least one target image.

In a possible implementation, the image generation mode selected by the user is a text-to-image mode, and the text-to-image mode refers to generating an image based on text information. When performing the step of obtaining input information from the user in the text-to-image mode, the acquisition module 702 is specifically configured to: determine and display first text description reference information based on the target style reference material selected by the user; and obtain the input information obtained by editing the first text description reference information by the user.

In a possible implementation, the image generation mode selected by the user is an image-to-image mode, and the image-to-image mode refers to generating an image based on image information. When performing the step of obtaining input information from the user in the image-to-image mode, the acquisition module 702 is specifically configured to: obtain an original image uploaded by the user, or, obtain an original image uploaded by the user and description information for the original image, the original image being from a local client of the user or from a target platform.

In a possible implementation, the acquisition module 702 is specifically configured to:
determine and display second text description reference information according to the original image uploaded by the user and the target style reference material selected by the user; and
obtain description information obtained by editing the second text description reference information by the user as the description information for the original image.

In a possible implementation, the generation module 703 is further configured to: obtain parameter information input by the user in response to at least one image generation parameter that is set.

The step of, according to the input information in the image generation mode and the target style reference material, generating and displaying at least one target image includes:
according to the parameter information input by the user for the at least one image generation parameter, the input information, and the target style reference material, generating and displaying the at least one target image.

In a possible implementation, in response to the image generation mode selected by the user being an image-to-image mode, the at least one image generation parameter comprises at least one selected from a group comprising an image structure retention intensity and a texture retention intensity; the image-to-image mode refers to generating an image based on image information, the image structure retention intensity is used for indicating a retention degree of edge lines of the original image uploaded by the user, and the texture retention intensity is used for indicating a retention degree of image texture of the original image uploaded by the user.

In a possible implementation, the apparatus further includes a processing module 704.

The processing module 704 is configured to display at least one image processing control; and in response to an image processing request for any one target image of the at least one target image, process the target image to obtain a processed image in accordance with an image processing mode corresponding to a selected image processing control.

In a possible implementation, the at least one image processing control comprises at least one of following controls: a first control corresponding to a super-resolution processing mode, a second control corresponding to a variation processing mode, a third control corresponding to an image-matting processing mode, and a fourth control corresponding to a creation-similar image processing mode.

The super-resolution processing mode refers to performing zoom-in processing on an image, the zoom-in processing refers to performing simultaneous zoom-in processing on an image in terms of resolution and size; the image-matting processing mode refers to performing foreground pixel extraction processing on an image; the variation processing mode refers to performing image detail adjustment processing on a premise of maintaining a consistent image style; the creation-similar image processing mode refers to recreating an image by adopting input information that is same as input information of a corresponding image, and after the fourth control is triggered, displaying the input information of the corresponding image again in the target interface.

In a possible implementation, the processing module 704 is specifically configured to:
in response to a triggering operation for a control list button displayed at a position of the target image, display the at least one image processing control at the position of the target image; or,
display a plurality of image generation modes and the at least one image processing control in an image generation mode option bar of the target interface.

For the descriptions of processing flows of the modules and the interaction flows among the modules in the apparatus, reference may be made to the relevant descriptions in the above-mentioned method embodiments, which will not be described in detail herein.

Corresponding to the image generation method in FIG. 1, an embodiment of the present disclosure further provides a computer device 800. FIG. 8 is a schematic structural diagram of the computer device 800 according to an embodiment of the present disclosure.

The computer device 800 includes a processor 801, a memory 802, and a bus 803. The memory 802 is used for storing execution instructions and includes an internal memory 821 and an external memory 822. The internal memory 821 herein, also referred to as an internal storage, is used for temporarily storing the computing data in the processor 801, as well as data exchanged with the external memory 822, such as a hard disk. The processor 801 exchanges data with the external memory 822 through the internal memory 821. When the computer device 800 runs, the processor 801 is in communication with the memory 802 via the bus 803, and the processor 801 is caused to execute the instructions for implementing the steps of the image generation method described in any embodiment of the present disclosure.

An embodiment of the present disclosure further provides a non-transitory computer-readable storage medium, the computer-readable storage medium stores a computer program. When the computer program is run by a processor, the steps of the image generation method described in the method embodiments above are performed. The storage medium may be a volatile or non-volatile computer-readable storage medium.

For the description of the effects of the image generation apparatus, the computer device, and the computer-readable medium described above, reference may be made to the description of the image generation method described above, which will not be repeated here.

An embodiment of the present disclosure further provides a computer program product, and the computer program product carries a program code. The program code includes instructions that may be used to execute the steps of the image generation method in the above-mentioned method embodiments. For details, please refer to the above method embodiments, which will not be repeated herein.

The above-mentioned computer program product may be implemented specifically by means of hardware, software, or a combination thereof. In one optional embodiment, the computer program product is specifically embodied as a computer storage medium, and in another optional embodiment, the computer program product is specifically embodied as a software product, such as an SDK (Software Development Kit), etc.

It may be clearly understood by a person skilled in the art that, for the purpose of convenience and brevity of the description, for a detailed working process of the above-described system and apparatus, reference may be made to a corresponding process in the above-described method embodiments, and details are not described again herein. In the several embodiments provided in the present disclosure, it should be understood that the disclosed system, apparatus, and method may be implemented in other manners. The above-described embodiments of the apparatus are merely schematic. For example, the division of the described modules is merely logical function division, and other division may be used in actual implementation. For example, a plurality of modules or components may be combined or integrated into another system, or some features may be ignored or may not be performed. In addition, the displayed or discussed mutual couplings or direct couplings or communication connections may be implemented by using some communication interfaces. The indirect couplings or communication connections between the apparatuses or modules may be implemented in electronic, mechanical, or other forms.

The modules described as separate parts may or may not be physically separated, and parts displayed as modules may or may not be physical modules, that is, may be located in one position, or may be distributed over a plurality of network modules. Some or all of the modules may be selected based on actual requirements to achieve the objectives of the solutions of the embodiments.

In addition, various functional modules in the embodiments of the present disclosure may be integrated into one processing module, or each of the modules may exist alone physically, or two or more modules may be integrated into one module.

When the functions are implemented in a form of a software functional module and sold or used as an independent product, the functions may be stored in a non-volatile computer-readable storage medium executable by the processor. Based on such an understanding, the technical solutions of the present disclosure essentially, or the part contributing to the prior art, or some of the technical solutions may be implemented in a form of a software product. The computer software product is stored in a storage medium, and includes several instructions for instructing a computer device (which may be a personal computer, a server, or a network device) to perform all or some of the steps of the methods described in the embodiments of the present disclosure. The aforementioned storage medium includes: any medium capable of storing program code, such as a USB flash drive, a removable hard disk, a read-only memory (ROM), a random-access memory (RAM), a magnetic disk, or an optical disk.

Finally, it should be noted that the above described embodiments are only specific embodiments of the present disclosure to illustrate the technical solutions of the present disclosure, not used to limit them, and the scope of protection of the present disclosure is not limited thereto. Although the present disclosure has been described in detail with reference to the foregoing embodiments, a person of ordinary skill in the art should understand that any person of skill in the art who is familiar with the technical field may, within the technical scope disclosed in the present disclosure, still be able to make modifications or conceivable variations that can be easily think of to the technical solutions described in the foregoing embodiments, or make equivalent substitutions for some of the technical features therein; and these modifications, changes, or substitutions, which do not take the essence of the corresponding technical solutions out of the spirit and scope of the technical solutions of the embodiments of the present disclosure, shall be covered within the scope of protection of the present disclosure. Therefore, the scope of protection of the present disclosure shall be based on the scope of protection of the claims.

The invention claimed is:

1. An image generation method, comprising:
displaying a target interface for performing intelligent image generation, wherein the target interface displays a plurality of style reference materials, and each of the plurality of style reference materials comprises style indication information and a corresponding sample image;
determining a target style reference material selected from the plurality of style reference materials by a user, and obtaining input information from the user in an image generation mode that is selected; and
according to the input information in the image generation mode and the target style reference material, generating and displaying at least one target image.

2. The method according to claim 1, wherein the image generation mode selected by the user is a text-to-image mode, and the text-to-image mode refers to generating an image based on text information;
the obtaining input information from the user in an image generation mode that is selected comprises:
determining and displaying first text description reference information based on the target style reference material selected by the user; and
obtaining the input information obtained by editing the first text description reference information by the user.

3. The method according to claim 1, wherein the image generation mode selected by the user is an image-to-image mode, and the image-to-image mode refers to generating an image based on image information;
the obtaining input information from the user in an image generation mode that is selected comprises:
obtaining an original image uploaded by the user, or, obtaining an original image uploaded by the user and description information for the original image, wherein the original image is from a local client of the user or from a target platform.

4. The method according to claim 3, wherein obtaining the description information for the original image from the user comprises:
determining and displaying second text description reference information according to the original image uploaded by the user and the target style reference material selected by the user; and
obtaining description information obtained by editing the second text description reference information by the user as the description information for the original image.

5. The method according to claim 1, wherein before the generating and displaying at least one target image, the method further comprises:
obtaining parameter information input by the user in response to at least one image generation parameter that is set;
the according to the input information in the image generation mode and the target style reference material, generating and displaying at least one target image comprises:
according to the parameter information input by the user for the at least one image generation parameter, the input information, and the target style reference material, generating and displaying the at least one target image.

6. The method according to claim 5, wherein in response to the image generation mode selected by the user being an image-to-image mode, the at least one image generation parameter comprises at least one selected from a group comprising an image structure retention intensity and a texture retention intensity; the image-to-image mode refers to generating an image based on image information, the image structure retention intensity is used for indicating a retention degree of edge lines of the original image uploaded by the user, and the texture retention intensity is used for indicating a retention degree of image texture of the original image uploaded by the user.

7. The method according to claim 1, further comprising:
displaying at least one image processing control; and
in response to an image processing request for any one target image of the at least one target image, processing the target image to obtain a processed image in accordance with an image processing mode corresponding to a selected image processing control.

8. The method according to claim 7, wherein the at least one image processing control comprises at least one of following controls:
a first control corresponding to a super-resolution processing mode, a second control corresponding to a variation processing mode, a third control corresponding to an image-matting processing mode, and a fourth control corresponding to a creation-similar image processing mode; and
the super-resolution processing mode refers to performing zoom-in processing on an image, the zoom-in processing refers to performing simultaneous zoom-in processing on an image in terms of resolution and size; the image-matting processing mode refers to performing foreground pixel extraction processing on an image; the variation processing mode refers to performing image detail adjustment processing on a premise of maintaining a consistent image style; the creation-similar image processing mode refers to recreating an image by adopting input information that is same as input information of a corresponding image, and after the fourth control is triggered, displaying the input information of the corresponding image again in the target interface.

9. The method according to claim 8, wherein the displaying at least one image processing control comprises:
in response to a triggering operation for a control list button displayed at a position of the target image, displaying the at least one image processing control at the position of the target image; or,
displaying a plurality of image generation modes and the at least one image processing control in an image generation mode option bar of the target interface.

10. The method according to claim 7, wherein the displaying at least one image processing control comprises:
in response to a triggering operation for a control list button displayed at a position of the target image, displaying the at least one image processing control at the position of the target image; or,
displaying a plurality of image generation modes and the at least one image processing control in an image generation mode option bar of the target interface.

11. A computer device, comprising a processor, a memory, and a bus,
wherein the memory stores machine-readable instructions executable by the processor, when the computer device runs, the processor is in communication with the memory via the bus, and when the machine-readable instructions are executed by the processor, steps of an image generation method are performed,
wherein the image generation method comprises:
displaying a target interface for performing intelligent image generation, wherein the target interface displays a plurality of style reference materials, and each of the plurality of style reference materials comprises style indication information and a corresponding sample image;
determining a target style reference material selected from the plurality of style reference materials by a user, and obtaining input information from the user in an image generation mode that is selected; and
according to the input information in the image generation mode and the target style reference material, generating and displaying at least one target image.

12. The computer device according to claim 11, wherein the image generation mode selected by the user is a text-to-image mode, and the text-to-image mode refers to generating an image based on text information;
when performing the obtaining input information from the user in an image generation mode that is selected, the processor is configured to:
determine and display first text description reference information based on the target style reference material selected by the user; and
obtain the input information obtained by editing the first text description reference information by the user.

13. The computer device according to claim 11, wherein the image generation mode selected by the user is an image-to-image mode, and the image-to-image mode refers to generating an image based on image information;
when performing the obtaining input information from the user in an image generation mode that is selected, the processor is configured to:
obtain an original image uploaded by the user, or, obtain an original image uploaded by the user and description information for the original image, wherein the original image is from a local client of the user or from a target platform.

14. The computer device according to claim 13, wherein when performing obtaining the description information for the original image from the user, the processor is configured to:
determine and display second text description reference information according to the original image uploaded by the user and the target style reference material selected by the user; and
obtain description information obtained by editing the second text description reference information by the user as the description information for the original image.

15. The computer device according to claim 11, wherein before the generating and displaying at least one target image, the method further comprises:
obtaining parameter information input by the user in response to at least one image generation parameter that is set;
when performing the according to the input information in the image generation mode and the target style reference material, generating and displaying at least one target image, the processor is configured to:
according to the parameter information input by the user for the at least one image generation parameter, the input information, and the target style reference material, generate and display the at least one target image.

16. The computer device according to claim 15, wherein in response to the image generation mode selected by the user being an image-to-image mode, the at least one image generation parameter comprises at least one selected from a group comprising an image structure retention intensity and a texture retention intensity; the image-to-image mode refers to generating an image based on image information, the image structure retention intensity is used for indicating a retention degree of edge lines of the original image uploaded by the user, and the texture retention intensity is used for indicating a retention degree of image texture of the original image uploaded by the user.

17. The computer device according to claim 11, wherein the method further comprises:
displaying at least one image processing control; and
in response to an image processing request for any one target image of the at least one target image, processing the target image to obtain a processed image in accordance with an image processing mode corresponding to a selected image processing control.

18. The computer device according to claim 17, wherein the at least one image processing control comprises at least one of following controls:
a first control corresponding to a super-resolution processing mode, a second control corresponding to a variation processing mode, a third control corresponding to an image-matting processing mode, and a fourth control corresponding to a creation-similar image processing mode; and
the super-resolution processing mode refers to performing zoom-in processing on an image, the zoom-in processing refers to performing simultaneous zoom-in processing on an image in terms of resolution and size; the image-matting processing mode refers to performing foreground pixel extraction processing on an image; the variation processing mode refers to performing image detail adjustment processing on a premise of maintaining a consistent image style; the creation-similar image processing mode refers to recreating an image by adopting input information that is same as input information of a corresponding image, and after the fourth control is triggered, displaying the input information of the corresponding image again in the target interface.

19. The computer device according to claim 17, wherein when performing the displaying at least one image processing control, the processor is configured to:
in response to a triggering operation for a control list button displayed at a position of the target image, display the at least one image processing control at the position of the target image; or,
display a plurality of image generation modes and the at least one image processing control in an image generation mode option bar of the target interface.

20. A non-transitory computer-readable storage medium, wherein the non-transitory computer-readable storage medium stores a computer program, and when the computer program is executed by a processor, steps of an image generation method are performed,
wherein the image generation method comprises:
displaying a target interface for performing intelligent image generation, wherein the target interface displays a plurality of style reference materials, and each of the plurality of style reference materials comprises style indication information and a corresponding sample image;
determining a target style reference material selected from the plurality of style reference materials by a user, and obtaining input information from the user in an image generation mode that is selected; and
according to the input information in the image generation mode and the target style reference material, generating and displaying at least one target image.
